(19) United States
(12) Patent Application Publication
(10) Pub. No.: US 2018/0078095 A1
(43) Pub. Date: Mar. 22, 2018

(54) COOKING MANAGEMENT DEVICE EQUIPPED WITH AN IMPROVED DISPLAY

(71) Applicant: SEB S.A., ECULLY (FR)

(72) Inventors: Philippe ROUSSARD, Le Noyer (FR); Claire MILLS, Annecy (FR)

(21) Appl. No.: 15/561,771

(22) PCT Filed: Mar. 24, 2016
(86) PCT No.: PCT/FR2016/050665

§ 371 Date: Sep. 26, 2017

(30) Foreign Application Priority Data
Mar. 27, 2015 (FR) 1552638

(51) Int. Cl. A47J 45/06; A47J 37/10

(52) U.S. Cl. CPC A47J 45/068; A47J 37/10; A47J 45/061

(57) ABSTRACT

A food cooking management device configured to be removably positioned on a cooking vessel, the cooking management device including a control device in which is stored data characterizing a type of cooking vessel on which the cooking management device is positioned and/or several cooking cycles activated by a control unit, as well as a segmented liquid crystal display that permits emitting visual signals to the user, wherein the control device is configured to activate one or more segments of the display to permit displaying a first icon representing a first type of cooking vessel corresponding to the stored data and/or a first cooking cycle activated, the control device being configured to display at least a second icon representing a second type of cooking vessel and/or a second cooking cycle by activating at least one segment activated to display the first icon

This invention concerns a food cooking management device intended to be removably positioned on a cooking vessel cooperating with a hot plate, the cooking vessel being in particular a frying pan, a saucepan, a Dutch oven or a pressure cooker. The invention also concerns a set including at least one cooking vessel and a cooking management device.

From the document U.S. Pat. No. 6,860,192, we are aware of a food cooking management device intended to be removably positioned on a cooking vessel, in particular a frying pan. The cooking management device includes a memory in which is stored the type of cooking vessel on which it is positioned. The type of cooking vessel in the memory can be accessed and modified manually by the user. The cooking management device includes a liquid crystal display which may segmented, in order to emit visual signals to the user. The cooking management device is designed to emit signals intended in particular to control a hot plate, and the signals emitted are adapted by the cooking management device according to the type of cooking vessel on which it is installed.

However, such a cooking management device includes a display which does not provide any indication of the type of cooking vessel on which it is positioned. Thus, the user must remember to check carefully, when fitting the cooking management device onto a cooking vessel, that it is configured properly for the right type of cooking vessel used. Otherwise, during cooking, the signals emitted by the cooking management device will not be adapted to the type of vessel and the cooking result will not be as desired.

The goal of this invention is to remedy the aforementioned drawbacks and to propose a cooking management device with improved ergonomics in order to guarantee the food cooking result.

Another goal of the invention is to propose a cooking management device that has a simple design and is economical to use.

Another goal of the invention is to propose a cooking management device with a reliable and repetitive operation, that is durable over time.

These goals are achieved with a cooking management device intended to be removably positioned on a cooking vessel, said cooking management device including a control device in which is stored data characterizing the type of cooking vessel on which it is positioned and/or several cooking cycles activated by a control unit, as well as a segmented liquid crystal display that permits emitting visual signals to the user, characterized in that the control device activates one or more segments of the display to permit displaying a first icon representing a first type of cooking vessel corresponding to the stored data and/or a first cooking cycle activated, the control device being designed to display at least a second icon representing a second type of cooking vessel and/or a second cooking cycle by activating at least one segment activated to display the first icon.

“A cooking management device intended to be removably positioned on a cooking vessel” is understood to mean that the cooking management device can easily be separated from the cooking vessel by the user, without the need to use a tool.

“The type of cooking vessel” is understood to mean the type and/or size of the cooking vessel.

“A cooking management device” is understood to mean in particular a cooking monitoring device permitting cooking management.

The use of a segmented liquid crystal display permits the implementation of a control device including a microcontroller equipped with a limited number of inputs/outputs, in particular in comparison to a matrix liquid crystal display which has a multitude of points to control, necessitating a microcontroller equipped with a large number of inputs/outputs. The cooking management device is consequently economical to use. A segment is understood to be an isolated element illustrating a portion of an icon or set of elements controlled simultaneously by an output of the microcontroller.

The display of the cooking management device displays an icon representing the type of cooking vessel on which it is positioned and/or the cooking cycle activated. The icon displayed permits the user to verify that the cooking management device is configured properly for the cooking vessel on which it is installed and/or that the cooking cycle activated actually corresponds to the cooking cycle implemented. Thus, the signals emitted by the cooking management device are always adapted to the type of cooking vessel and/or the cooking cycle implemented. Consequently, the signals emitted are reliable and make it possible to guarantee the food cooking result.

“The control device activates one or more segments of the display to permit displaying a first icon representing a first type of cooking vessel corresponding to the stored data and/or a first cooking cycle activated” is understood to mean that the icon is present for the entire period during which the cooking cycle is activated. Other icons, in particular to alert the user, may be displayed at the same time as the icon representing the cooking cycle activated. A cooking cycle is understood to be a cooking method.

In addition, in order to display the first and

second icons, the control device activates at least one common segment. Such an arrangement permits reducing the number of segments of the display as well as its size.

Advantageously, the control device activates a segment in the shape of a flattened “U” having two short side branches, in order to display the first icon representing a frying pan, the stored data characterizing a frying pan.

Thus, a first icon representing a frying pan can be displayed by activating a segment. Such an arrangement makes it possible to display an icon representing a frying pan in a very economical manner.

Preferably, the control device activates the segment in the shape of a flattened “U” having two short side branches, as well as a segment formed of two straight lines extending from the side branches, in order to display the second icon representing a saucepan or a Dutch oven, the stored data characterizing a saucepan or a Dutch oven.

Thus, a second icon representing a saucepan or a Dutch oven may be displayed by activating a segment in addition to the segment activated to display the frying pan icon. Such an arrangement makes it possible to display two icons representing a frying pan or a saucepan or a Dutch oven in a very economical manner.

Advantageously, the number of segments activated by the control device to form the first and second icons is lower than 5, preferably lower than 3.

Advantageously, the control device activates the segment in the shape of a flattened “U” having two short side branches, the segment formed of two straight lines extending from the side branches, as well as a curved segment and a segment formed of two hooks and a vertical line, in order to display a third icon representing a pressure cooker, the stored data characterizing a pressure cooker.

Thus, a third icon representing a pressure cooker may be displayed by activating two segments in addition to the segment activated to display the frying pan icon and a segment activated to display the saucepan icon or the Dutch oven icon. Such an arrangement makes it possible to display three icons representing a frying pan or a saucepan or a Dutch oven or a pressure cooker in a very economical manner.

Preferably, the number of segments activated by the control device to form the first, second and third icons is lower than 7, preferably lower than 5.

Advantageously, the control device activates at least one segment of the display in order to display the icon representing the cooking cycle, when it activates the segment or segments representing the icon representing the type of cooking vessel.

Preferably, the cooking management device includes a manual control unit that permits the user to modify the data characterizing the type of cooking vessel stored.

Advantageously, the cooking management device includes an automatic recognition system that permits autonomously modifying the data characterizing the type of cooking vessel stored.

Thus, the cooking management device autonomously recognizes the type of cooking vessel on which it is positioned. Thus, the signals emitted by the display of the cooking management device are always adapted to the type of cooking vessel recognized.

Preferably, the cooking management device includes connection means,

in particular pads, connected to the control device, the connection means being intended to cooperate with a temperature sensor positioned on the cooking vessel.

Thus, the control device is connected electrically and removably to a temperature sensor which provides data representing the food cooking temperature. The control device may adjust the signals emitted by the display according to the measurements taken on the sensor.

Advantageously, the control device activates a substantially rectangular segment of the display, including a notch representing a food to be prepared, the control device activating a segment formed of several short lines positioned above the food when the “sear” cycle is activated to display a first icon, or a segment formed of several short lines positioned above the notch when the “cook thoroughly” cycle is activated to display a second icon, or a segment formed of several disks positioned above the food when the “simmer” cycle is activated to display a third icon.

Thus, the control device activates at least one common segment in order to display the first, second and third icons, corresponding to the cooking cycle activated. Such an arrangement permits reducing the number of segments of the display as well as its size.

Advantageously, the control device activates one or more display segments to display an icon representing the cooking cycle activated, as well as the icon representing the type of cooking vessel corresponding to the data stored, the icon representing the cooking cycle being designed to be displayed inside the icon representing the type of cooking vessel.

The display of the cooking management device displays an icon combining an icon representing the type of cooking vessel and an

icon representing the cooking cycle selected, the icon representing the cooking cycle selected being inserted inside the icon representing the type of cooking vessel. Thus, the surface area of the display may be reduced.

The invention also concerns a set formed of at least one cooking vessel and a cooking management device as described above.

Advantageously, the cooking vessel includes a handle, the cooking management device being positioned on the handle.

It is understood that the handle may be a long handle positioned on a frying pan or a loop handle positioned on a saucepan or a Dutch oven.

Such an arrangement makes it possible to produce in an economic manner a cooking management device which can be installed on a set of cooking vessels. In fact, the area where the cooking management device is attached to the handle is identical for each cooking vessel.

The invention will be more fully understood in consideration of the embodiments, which are in no way restrictive, illustrated in the attached figures, in which:

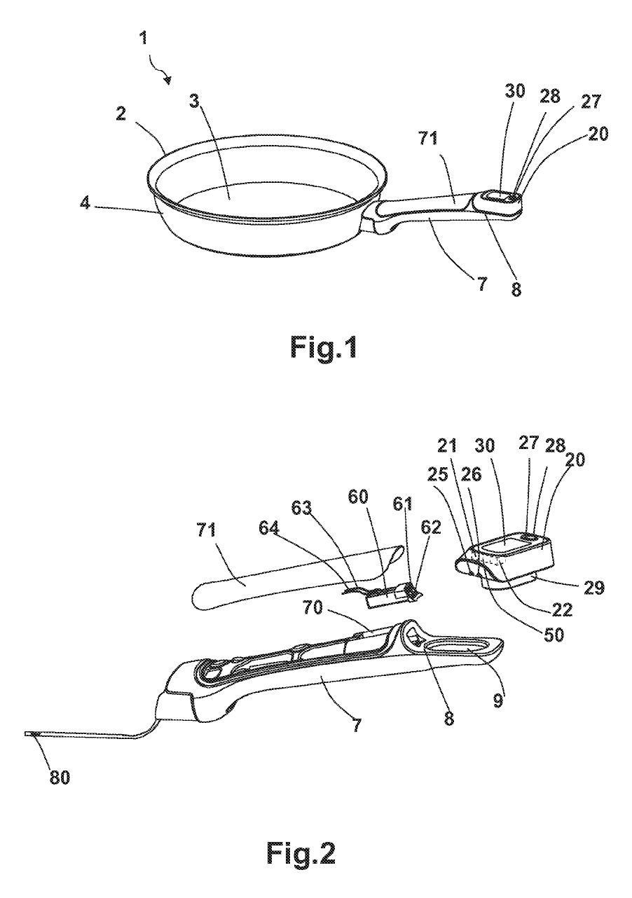

FIG. 1 illustrates a perspective view of a cooking vessel including a cooking management device according to a particular embodiment of the invention.

FIG. 2 illustrates an exploded perspective view of the handle of the cooking vessel including the cooking management device illustrated in FIG. 2.

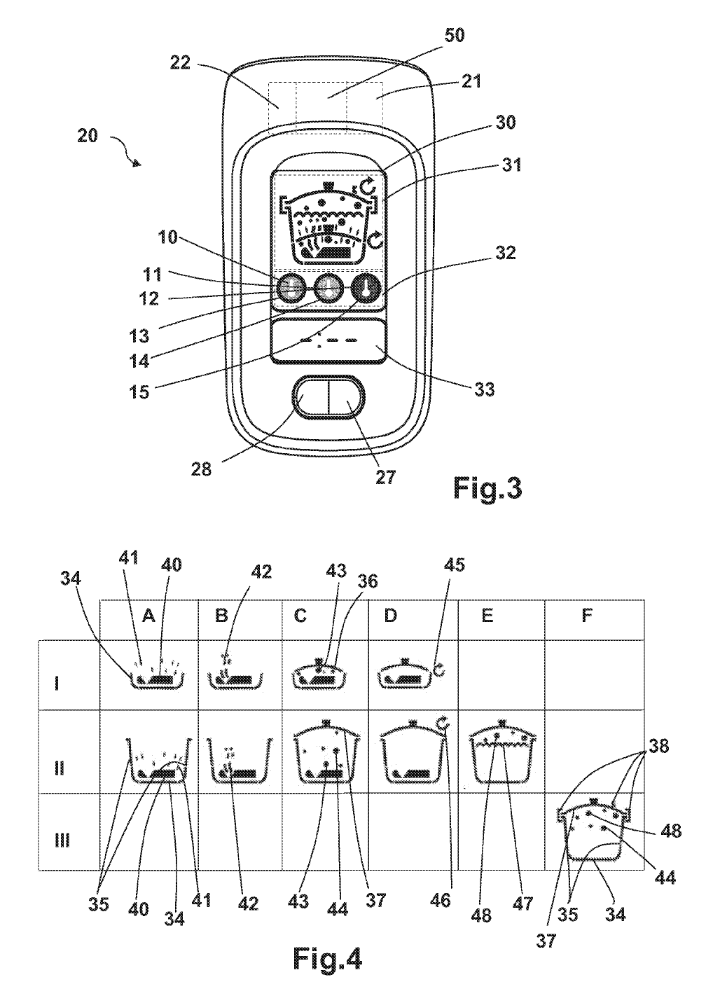

FIG. 3 illustrates a top view of the cooking management device illustrated in FIG. 1, as well as the display.

FIG. 4 illustrates a table of icons displayed by the display illustrated in FIG. 3, according to the type of cooking vessel and the cooking cycle.

As seen in FIGS. 1 to 2, a cooking vessel 1 includes a bowl 2 which includes a bottom 3 and a side wall 4. The bowl 2 is made of a non-magnetic material, in particular of aluminum, for example by striking a disk or by casting. The bottom 3 presents a thickness in which is inserted a temperature sensor 80, in particular a thermocouple or a negative temperature coefficient resistor. The cooking vessel 1 includes a handle 7 in which is removably positioned a cooking management device 20. The cooking management device 20 is connected, for example electrically, to the temperature sensor 80 in order to receive information representing the temperature of the bottom 3. The cooking management device includes a display 30 and a control device 50, in particular of the display 30.

As seen in FIG. 2, the handle 7 includes a cavity 70 in which is positioned a connector 60. The cavity 70 is closed with a cover 71. The connector 60 is equipped with a first contact area 61 and a second contact area 62. The first contact area 61 and second contact area 62 are connected to the temperature sensor 80 by two conductive parts 63, 64. The cooking management device 20 includes the first pad 25 and the second pad 26 connected to the control device 50 and intended to cooperate with the first contact area 61 and second contact area 62. The handle 7 includes a housing 8 equipped with a through opening 9. The cooking management device 20 includes a foot 29 intended to cooperate with the through opening 9 in order to keep the cooking management device 20 on the handle 7, as well as the first pad 25 and the second pad 26 in contact with the first contact area 61 and the second contact area 62. The foot 29 may hold a supply battery (not shown in the figures) of the cooking management device 20. Advantageously, the through opening 9 is intended to form a ring for hanging up the cooking vessel 1.

The control device 50 includes a system 21 to recognize automatically the type of cooking vessel 1 on which the cooking management device 20 is positioned. The automatic recognition system 21 acts on the display 30 to adapt the signals emitted by the display 30 according to

the type of cooking vessel 1 recognized.

The cooking management device 20 is intended to cooperate with different types of cooking vessels each including a temperature sensor 80, in particular a thermocouple with a specific resistance range characteristic of the type of cooking vessel. The automatic recognition system 21 includes a memory 22 in which are stored the resistance value ranges, each value range being associated with data characterizing the type of cooking vessel. The automatic recognition system 21 is designed to detect the resistance value of the thermocouple and, based on the value ranges stored, to determine the data characterizing the type of cooking vessel and store it in the memory 22. The control device 50 controls the display 30 according to the data stored in the memory 22.

The cooking management device 20 includes an on/off button 28. Each time the device is switched on, the automatic recognition system 21 is activated to detect the type of cooking vessel on which the cooking management device 20 is installed.

In accordance with FIG. 3, the display 30 includes an area 31 presenting a particular arrangement of segments, intended to display icons representing a type of cooking vessel and icons representing cooking cycles. The cooking icons are stored in the memory 22 and the cooking management device 20 includes a control unit 27 which permits activating a cooking cycle. The control device 50 displays in the area 31 the icon representing the cooking cycle activated.

FIG. 4 illustrates a table of icons displayed by the area 31 of the display 30 according to the type of cooking vessel and the cooking cycle selected. Advantageously, the icon representing the cooking cycle is inserted inside the icon representing the

cooking vessel.

The type of cooking vessel characterized by data referenced as I in the memory 22 corresponds to a frying pan. The control device 50 activates a segment 34 of the display 30 in the shape of a flattened “U” having two short side branches, in order to display the icon representing a frying pan.

The type of cooking vessel characterized by data referenced as II corresponds to a saucepan or a Dutch oven. The control device 50 activates the segment 34 in the shape of a flattened “U” having two short side branches, as well as a segment 35 formed of two straight lines extending from the side branches, in order to display the icon representing a saucepan or a Dutch oven.

The type of cooking vessel referenced as III corresponds to a pressure cooker. The control device 50 activates the segment 34, the segment 35 as well as a curved segment 36 and a segment 38 formed of two hooks and a vertical line, in order to display a third icon representing a pressure cooker. The hooks represent locking of the lid and the vertical line represents the steam exhaust valve.

The cooking cycle referenced as A corresponds to the “sear” cycle compatible with a frying pan or a saucepan or a Dutch oven. The control device 50 activates a substantially rectangular segment 40 of the display including a notch representing a food to be prepared and a segment 41 formed of several short lines positioned above the food representing a release of heat.

The cooking cycle referenced as B corresponds to the “cook thoroughly” cycle compatible with a frying pan or a saucepan or a Dutch oven. The control device 50 activates the segment 40 and a segment 42 formed of several short lines positioned above the notch representing a release of heat from inside the food.

The cooking cycle referenced as C corresponds to the “simmer” cycle compatible with a frying pan or a saucepan or a Dutch oven. The control device 50 activates the segment 40 and a segment 43 formed of several disks

positioned above the food, representing a release of steam bubbles. The control device 50 also activates a curved segment 37 representing a lid when the cooking vessel is a frying pan. The control device 50 activates a segment 44 formed of several disks and the curved segment 36 representing a lid when the cooking vessel is a saucepan or a Dutch oven.

The cooking cycle referenced as D corresponds to the “heat” cycle compatible with a frying pan or a saucepan or a Dutch oven. The control device 50 activates the segment 40 and a segment 45, 46 formed of a circular arrow positioned above the cooking vessel, representing the heating symbol. The control device 50 also activates the curved segment 36 or the curved segment 37.

The cooking cycle referenced as E corresponds to the “boil” cycle compatible with a saucepan or a Dutch oven. The control device 50 activates a segment 47 formed of a wavy line and a segment 48 formed of several disks positioned above the line, representing a release of steam bubbles above a liquid food. The control device 50 also activates the curved segment 37.

The cooking cycle referenced as F corresponds to the “pressure cook” cycle compatible with a pressure cooker. The control device 50 activates the segments 44, 48 formed of several disks representing a release of steam bubbles.

As seen in FIG. 3, the display 30 includes an area 32 with information on the cooking temperature status of the cooking vessel in relation to the cooking cycle selected. The area 32 includes three color icons 10, 11, 12 printed on the display 30: a blue icon 10, a green icon 11 and a red icon 12. The control device 50 activates a circular segment 13 surrounding the green icon 10 in order to indicate to the user that the cooking temperature is correct. The control device 50 activates a circular segment 14 surrounding the blue icon 11 in order to indicate to the user that the cooking temperature is too low and that the user can increase the heating power. The control device 50 activates a

circular segment 15 surrounding the red icon 12 in order to indicate to the user that the cooking temperature is too high and to prompt the user to reduce the cooking power.

The display 30 includes an area 33 forming a timer to display cooking times.

During use, the user chooses a cooking vessel 1 adapted to the size and/or type of food the user wishes to prepare, such as a frying pan, for example, and the user fits the cooking management device 20 onto this cooking vessel. The user then turns on the cooking management device 20, which activates the automatic recognition system 21 which detects the resistor value of the temperature sensor 80. The automatic recognition system 21 then determines that it is positioned on a frying pan and the control device 50 activates a segment 34 of the display in the shape of a flattened “U” having two short side branches, in order to display the icon representing a frying pan. The user then selects the cooking cycle using the control unit 27, such as the “sear” cycle, for example. The control device 50 activates a substantially rectangular segment 40 of the display including a notch representing a food to be prepared and a segment 41 formed of several short lines positioned above the food representing a release of heat. The user then places the cooking vessel 1 on a hot plate that the user has previously switched on. During food preparation, the control device 50 will activate, depending on the heating cycle selected, one of the circular segments 13, 14, 15 surrounding one of the colored icons 10, 11, 12 in order to indicate to the user the cooking temperature status and to permit the user to adjust the heating power if necessary.

Of course, the invention is in no way limited to the embodiments described and illustrated, which have been provided only as examples. Modifications are still possible, in particular from the point of view of composition of the various components or by substitution of equivalent techniques, without departing

from the scope of protection of the invention.

Thus, in one variant, the cooking management device 20 includes a radio wave transceiver, in particular a Bluetooth® transceiver, to cooperate with a remote terminal, in particular a smartphone, which has an application containing recipes, each recipe being associated with a cooking cycle.

1. A food cooking management device configured to be removably positioned on a cooking vessel, said cooking management device including a control device in which is stored data characterizing a type of cooking vessel on which it the cooking management device is positioned and/or several cooking cycles activated by a control unit, as well as a segmented liquid crystal display that permits emitting visual signals to the user, wherein the control device is configured to activate one or more segments of the display to permit displaying a first icon representing a first type of cooking vessel corresponding to the stored data and/or a first cooking cycle activated, the control device being configured to display at least a second icon representing a second type of cooking vessel and/or a second cooking cycle by activating at least one segment activated to display the first icon.

2. The food cooking management device according to claim 1, wherein the control device is configured to activate a segment in the shape of a flattened “U” having two short side branches, in order to display the first icon representing a frying pan, the stored data characterizing a frying pan.

3. The food cooking management device according to claim 2, wherein the control device activates is configured to activate the segment in the shape of a flattened “U” having two short side branches, as well as a segment formed of two straight lines extending from the side branches, in order to display the second icon representing a saucepan or a Dutch oven, the stored data characterizing a saucepan or a Dutch oven.

4. The food cooking management device according to claim 3, wherein the control device is configured to activate the segment in the shape of a flattened “U” having two short side branches, the segment formed of two straight lines extending from the side branches, as well as a curved segment and a segment formed of two hooks and a vertical line, in order to display a third icon representing a pressure cooker, the stored data characterizing a pressure cooker.

5. The food cooking management device according to claim 4, wherein a number of segments activated by the control device to form the first, second and third icons is lower than 7.

6. The food cooking management device according to claim 1, further comprising a manual control unit that permits the user to modify the data characterizing the type of cooking vessel stored.

7. The food cooking management device according to claim 1, further comprising an automatic recognition system that permits autonomously modifying the data characterizing the type of cooking vessel stored.

8. The food cooking management device according to claim 1, further comprising a connection system connected to the control device, the connection system being configured to cooperate with a temperature sensor positioned on the cooking vessel.

9. The food cooking management device according to claim 1, wherein the control device is configured to activate a substantially rectangular segment of the display, including a notch representing a food to be prepared, the control device activating a segment formed of several short lines positioned above the food when a sear cycle is activated to display a first icon, or a segment formed of several short lines positioned above the notch when a cook thoroughly cycle is activated to display a second icon, or a segment formed of several disks positioned above the food when a simmer cycle is activated to display a third icon.

10. The food cooking management device according to claim 1, wherein the control device is configured to activate one or more display segments to display an icon representing the cooking cycle activated, as well as the icon representing the type of cooking vessel corresponding to the data stored, the icon representing the cooking cycle being designed to be displayed inside the icon representing the type of cooking vessel.

11. A set formed of at least one cooking vessel and a cooking management device according to claim 1.

12. The set according to claim 11, wherein the cooking vessel includes a handle, the cooking management device being positioned on the handle.

13. The food cooking management device according to claim 5, wherein the number of segments activated by the control device to form the first, second and third icons is lower than 5.

14. The food cooking management device according to claim 8, wherein the connection system includes pads.
